(19) United States
(12) Patent Application Publication
(10) Pub. No.: US 2005/0134525 A1
(43) Pub. Date: Jun. 23, 2005

(54) Control system for a tiled large-screen emissive display

(76) Inventors: Gino Tanghe, Merksem (BE); Nele Dedene, Houthalen-Helchteren (BE); Herbert Van Hille, Cambridge, MA (US); Robbie Thielemans, Nazareth (BE)

Correspondence Address: BARNES & THORNBURG, P.O. BOX 2786, CHICAGO, IL, 60690-2786, US

(21) Appl. No.: 10/743,970

(22) Filed: Dec. 23, 2003

(51) Int. Cl. G09G 5/00

(52) U.S. Cl. 345/1.1

(57) ABSTRACT

The present invention relates to a method of controlling a modular, tiled, large-screen emissive display application, e.g. an OLED display application. The method of controlling e.g. includes a first control level (214) for controlling the emissive devices, a second control level (212) for controlling the emissive display modules and a third control level for controlling the emissive display tiles (210). The number of control levels can be larger or it can be restricted to two levels. The method of controlling according to the present invention allows for similar control and calibration algorithms to be run at all levels, and allows for distributed processing in order to reduce bandwidth requirements and processing complexity. Furthermore, the control method of the present invention includes a method of operating and a method of monitoring a modular, tiled, large-screen emissive display.

### FIELD OF THE INVENTION

The present invention relates to a control system and method for a modular large-screen emissive display such as an organic light-emitting diode (OLED) display.

### BACKGROUND OF THE INVENTION

OLED technology incorporates organic luminescent materials that, when sandwiched between electrodes and subjected to a DC electric current, produce intense light of a variety of colors. These OLED structures can be combined into the picture elements, or pixels, that comprise a display. OLEDs are also useful in a variety of applications as discrete light-emitting devices or as the active element of light-emitting arrays or displays, such as flat-panel displays in watches, telephones, laptop computers, pagers, cellular phones, calculators, and the like. To date, the use of light-emitting arrays or displays has been largely limited to small-screen applications such as those mentioned above.

The market is now, however, demanding larger displays with the flexibility to customize display sizes. For example, advertisers use standard sizes for marketing materials; however, those sizes differ based on location. Therefore, a standard display size for the United Kingdom differs from that of Canada or Australia. Additionally, advertisers at trade shows need bright, eye-catching, flexible systems that are easily portable and easy to assemble/disassemble. Still another rising market for customizable large display systems is the control room industry, in which maximum display quantity, quality, and viewing angles are critical. Demands for large-screen display applications possessing higher quality and higher light output has led the industry to turn to alternative display technologies that replace older LED and liquid crystal displays, i.e. LCDs. For example, LCDs fail to provide the bright, high light output, larger viewing angles, and high resolution and speed requirements that the large-screen display market demands. By contrast, OLED technology promises bright, vivid colors in high resolution and at wider viewing angles. However, the use of OLED technology in large-screen display applications, such as outdoor or indoor stadium displays, large marketing advertisement displays, and mass-public informational displays, is only beginning to emerge.

Modular or tiled emissive displays, such as e.g. tiled OLED displays, are made from smaller modules or displays that are then combined into larger tiles. These tiled emissive displays are manufactured as a complete unit that can be further combined with other tiles to create displays of any size and shape. However, in order to handle the control algorithms for large-screen emissive displays, very complex control software with high bandwidth and a high level of processing power is required. What is needed is a less complex software control system for control and calibration of a large-screen emissive display. Furthermore, what is further needed is software control system for automatically configuring a modular, scalable, tiled emissive display.

An example of a software control system for a display is described in U.S. Pat. No. 5,739,809. The system described includes a processor programmed to control and optionally also calibrate a display in response to user selection of displayed virtual controls. Preferred embodiments of the system include circuitry within the display device, which operates under control of software in response to user-entered commands for adjustment of parameters of the display device. In preferred embodiments, the processor is programmed with software that stores multiple types of data, including display parameters measured during calibration and user-specified adjustment data indicative of differences between first and second sets of display control parameters, in separate data files. The software also executes a locking operation that disables mechanical controls on the display device, periodically and automatically polls the status of the display, and automatically corrects any display parameter with a value that differs from a desired value.

Although the display calibration and control method described in U.S. Pat. No. 5,739,809 provides a suitable means for controlling a display apparatus, the software control system described is very complex for use in a large-screen emissive display application.

### SUMMARY OF THE INVENTION

It is therefore an object of the invention to provide a system and method for controlling and calibrating a tiled large-screen emissive display with reduced software complexity as compared with conventional systems.

It is yet another object of this invention to provide a control system an method capable of associating and configuring multiple emissive display tiles automatically within a tiled large-screen emissive display application.

The above objectives are accomplished by a method and device according to the present invention.

The present invention relates to a method for controlling a tiled large-screen emissive display. The emissive display comprises at least a plurality of first subdivisions, each of said first subdivisions comprising a plurality of emissive devices. The method comprises
for each of the first subdivisions, setting the emissive devices so that each of said first subdivisions is optimized with respect to a first subdivision target value for that first subdivision and
   after setting the emissive devices,
for the emissive display, setting the first subdivisions so that said emissive display is optimized with respect to an emissive display target value for said emissive display. In this embodiment of the method, the first subdivisions may be emissive display tiles.

The method of controlling a tiled large-screen emissive display can also comprise control on additional levels. The plurality of first subdivisions of the tiled large-screen emissive display may then be grouped into a plurality of second subdivisions, the number of first subdivisions being larger than the number of second subdivisions. Setting the first subdivisions in the method of controlling as described above may then be performed by
for each of the second subdivisions, setting the first subdivisions so that each of said second subdivisions is optimized with respect to a second subdivision target value for that second subdivision, and thereafter
for the emissive display, setting the second subdivisions so that the emissive display is optimized with respect to an emissive display target value for said emissive display.

In this embodiment of the method, the first subdivisions may e.g. refer to emissive display modules, while the second subdivisions may refer to emissive display tiles. The implementation of the first and second subdivisions may depend on the implementation of the display.

If a further level of control is introduced for a tiled large-screen emissive display wherein the plurality of second subdivisions are grouped into a plurality of further subdivisions, the number of further subdivisions being smaller than the number of second subdivisions; said setting the second subdivisions in the method of controlling may be performed by
for each further subdivision, setting the second subdivisions so that the further subdivision is optimized with respect to a further subdivision target value for said further subdivision, and thereafter
for the emissive display, setting the further subdivisions so that the emissive display is optimized with respect to an emissive display target value for said emissive display.

The further subdivisions may e.g. relate to supertiles, grouping a number of tiles e.g. each being an array of r by s tiles.

In a specific embodiment, a method is disclosed for controlling a tiled large-screen emissive display. The emissive display comprises a set of emissive display tiles, each of said emissive display tiles comprising a set of emissive display modules and each of said emissive display modules comprising a plurality of emissive display devices. The method comprises
for each emissive display module, setting the emissive display devices so that each emissive display module is optimized with respect to a module target value for that emissive display module,
for each emissive display tile, setting the emissive display modules taking into account the module target value for each emissive display module, so that each emissive display tile is optimized with respect to a tile target value for that emissive display tile, and
for the emissive display, setting the emissive display tiles taking into account the tile target values for each emissive display tile so that the emissive display is optimized with respect to a display target value for that emissive display.

The emissive display can be an OLED display or any other type of emissive display. Although in the detailed description an illustration is given for controlling the tiled large-screen emissive display on three levels, i.e. devices—also called pixels—, modules and tiles, the number of levels for controlling the tiled large-screen emissive display can be larger, e.g. by introducing super tiles grouping a number of tiles e.g. each an array of r by s tiles, or even by introducing super super tiles grouping a number of super tiles. On the other hand, the number of control levels also can be limited to two levels, i.e. controlling the devices or pixels and the tiles.

In the above described methods, setting the emissive devices may comprise setting the emissive devices so that they are within 10%, preferably within 5%, most preferably within 0.8% of the first subdivision target value of that first subdivision. Furthermore setting the first subdivisions may comprise setting the first subdivisions so that they are within 10%, preferably within 5%, most preferably within 0.8% of the emissive display target value of that emissive display or within 10%, preferably within 5%, most preferably within 0.8% of the second subdivision target value of that second subdivision, depending on the number of control levels that are used in the method of controlling, i.e. depending on the presence of a set of second subdivisions wherein the plurality of first subdivisions may be grouped.

In a similar way, depending on the number of control levels, setting the second subdivisions may comprise setting the second subdivisions so that they are within 10%, preferably within 5% and most preferably within 0.8% of the emissive display target value of the emissive display or within 10%, preferably within 5% and most preferably within 0.8% of the further subdivision target value of that further subdivision. The latter occurs if the second subdivisions are grouped in a set of further subdivisions, which are themselves grouped in the emissive display.

If further subdivisions are present, setting the further subdivisions may be so that they are within 10%, more preferably within 5% and most preferably within 0.8% of the emissive display target value of the emissive display.

In case of all the above limitations are target values, the actual target value that can be reached can depend on the parameter that is chosen as the target parameter, for example, 0.8% can be achieved for the parameter brightness. This would be a severe condition, for other parameters good target level values could be higher than 0.8%.

In determining any or more of the first subdivision target value, second subdivision target value, further subdivision target value and/or emissive display target value, an environmental parameter may be taken into account. The different target values correspond with the different control levels that are introduced. This environmental parameter may be obtained by measuring a temperature of at least one emissive device, first subdivision, second subdivision or further subdivision. This also may include measuring an ambient temperature and estimating the temperature of at least one emissive device, first subdivision, second subdivision or further subdivision from the measured ambient temperature. The environmental parameter also may be any or more of ambient illumination, ambient humidity.

Determining any or more of the first subdivision target value, second subdivision target value, further subdivision target value and/or emissive display target value, may include taking into account an operating parameter stored on the first subdivision or, if present, second subdivision or further subdivision. This operating parameter may comprise any or more of age (e.g. determined by the voltage change across the emissive elements) of the first subdivision or—if present—of the second subdivision or of the further subdivision, or total ON time of the first subdivision or—if present—of the second subdivision or of the further subdivision.

Setting the emissive devices also may comprise retrieving and adjusting a control parameter.

Setting the emissive devices, the first subdivisions, the second subdivisions and the further subdivisions may also comprise using an adaptive calibration algorithm for calibrating the emissive devices, the first subdivisions, the second subdivisions and the further subdivisions. This calibration may be performed periodically. It may comprise calibration of brightness and/or color.

The invention also relates to a computer program product for executing a method of controlling a tiled large-screen emissive display according to the present invention when executed on a computing device associated with a tiled large-screen emissive display, the methods of controlling being according to the methods described above. The invention further relates to a readable data storage device storing this computer program or to the transmission of this computer program over a local or wide area telecommunications network.

The invention furthermore relates to a control unit for use with a tiled large-screen emissive display, said emissive display comprising a set of first subdivisions, each of said first subdivisions comprising a plurality of emissive devices, the control unit being adapted for controlling setting of the tiled large-screen emissive display, the control unit comprising:
means for setting the emissive devices of each first subdivision so that each first subdivision is optimized to a first subdivision target value for that first subdivision,
means for setting the first subdivisions of the emissive display taking into account the first subdivision target value for each first subdivision, so that the emissive display is optimized to an emissive display target value for that emissive display.

If a larger number of control levels is used, e.g. if the first subdivisions are grouped in a set of second subdivisions, the means for setting the first subdivisions may comprise
means for setting the first subdivisions of each of the second subdivisions, taking into account the first subdivision target value for each first subdivision, so that the second subdivisions are optimized to a second subdivision target value for that second subdivision and
means for setting the second subdivisions of the emissive display taking into account the second subdivision target values for each second subdivision, so that the emissive display is optimized to an emissive display target value for that emissive display.

The devices, first subdivisions, second subdivisions and further subdivisions may relate to emissive display pixels, emissive display modules, emissive display tiles and emissive display supertiles respectively. The number of control levels used for controlling the tiled large-screen display can be even larger, depending on the need and the size of the large-screen display. Extrapolation of the above to more control levels lies within the skills of a person skilled in the art.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 is a functional block diagram of a large-screen OLED display system having a modular architecture and being suitable for use with the control system of the present invention.

FIG. 2A schematically illustrates the application of a multi-line method of signal and power distribution for an OLED display.

FIG. 2B schematically illustrates the application of a daisy-chain method of signal and power distribution for an OLED display.

FIG. 3 illustrates a functional block diagram of an OLED display control system in accordance with an embodiment of the present invention.

FIG. 4 illustrates a flow diagram of a method of operating a tiled OLED display using the OLED display control system according to an embodiment of the present invention.

FIG. 5 illustrates a flow diagram of a method of monitoring a tiled OLED display using the OLED display control system according to an embodiment of the present invention.

### DETAILED DESCRIPTION OF ILLUSTRATIVE EMBODIMENT

The present invention will be described with respect to particular embodiments and with reference to the drawings, but the invention is not limited thereto but only by the claims. The drawings are only schematic and are non-limiting. In the drawings, the size of some of the elements may be exaggerated and not drawn on scale for illustrative purposes.

The present invention relates to a control system for use with a modular, tiled, large-screen emissive display application. The control system of the present invention performs operations to initialize and configure an emissive display system during the physical assembly of emissive tiles, addresses the emissive display tiles, and controls the emissive display tiles for uniform image and proper image size. Furthermore, the control system of the present invention handles additional features, such as hot swap capability to replace failed emissive display tiles and a mechanism to detect a new emissive display tile, and video features, such as gamma curve adjustments, color point adjustments, brightness adjustments, and high broadcast capability. Based upon a known data stream, the control system determines the video content and makes adjustments accordingly. Lastly, the control system of the present invention is able to convert display deficiencies into features, i.e. compensates for deficiencies to improve display image while hiding a particular deficiency.

By way of example, the method and system for controlling a tiled large-screen emissive display system will be described with respect to a tiled large-screen OLED display system. Nevertheless, the method and system for controlling the tiled large-screen emissive display are not limited to OLED tiles but any emissive display tiles suitable for tiled large-screen emissive displays can be used.

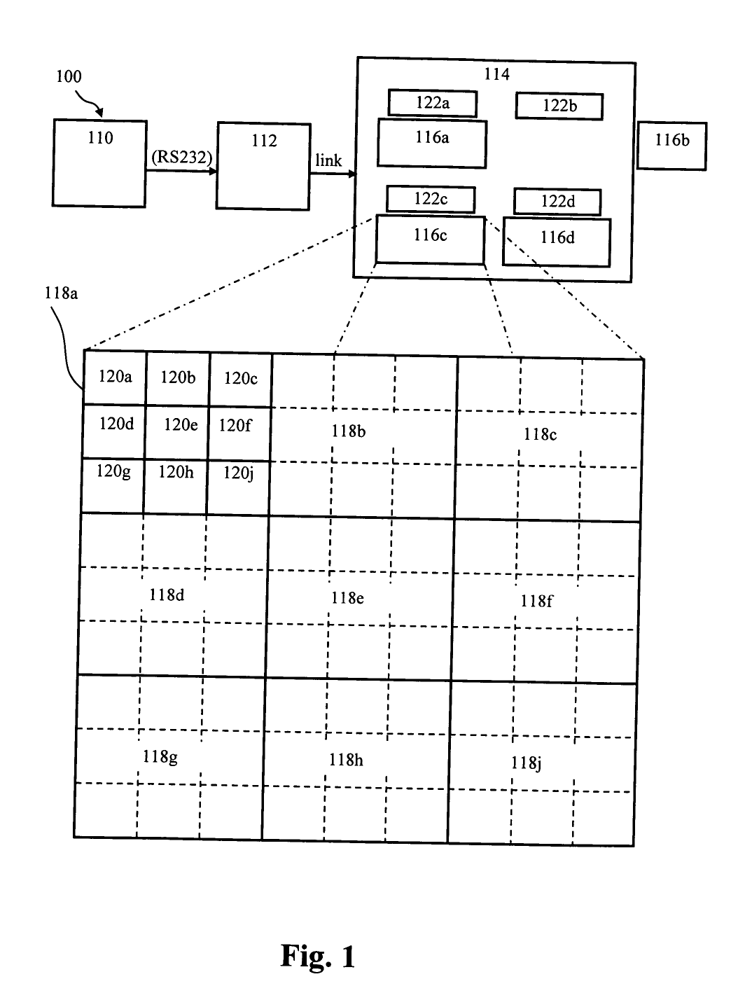

FIG. 1 is a functional block diagram of a large-screen OLED display system 100 having a modular architecture and being suitable for use with the control system according to embodiments of the present invention. OLED display system 100 includes a system controller 110, a digitizer 112, and a display wall 114 that further includes a collection of OLED sub-displays 116, for example, OLED sub-displays 116a, 116b, 116c, and 116d. Also shown in FIG. 1, as an example, is an expanded view of OLED sub-display 116c. In this example, OLED sub-display 116c further includes an n×m array, e.g. a 3×3 array, of OLED tiles 118. More specifically, OLED sub-display 116c includes OLED tiles 118a, 118b, 118c, 118d, 118e, 118f, 118g, 118h, and 118j. Furthermore, each of OLED tiles 118 includes a p×q array, e.g. a 3×3 array, of OLED modules 120. More specifically, each OLED tile 118 comprises, in the example given, OLED modules 120a, 120b, 120c, 120d, 120e, 120f, 120g, 120h, and 120j. Additionally, each OLED module 120 further includes an array of OLED devices (not shown in detail in the drawings), i.e. for example an array of red, green, blue (RGB) pixels. In general, the 3×3 arrangements shown in FIG. 1 are simply illustrative in nature; OLED sub-displays 116a, 116b, 116c, and 116d each may include any number of OLED tiles 118 and, similarly, OLED tiles 118 each may include any number of OLED modules 120. Lastly, OLED display system 100 includes one or more ambient environment controllers (AECs) 122, for example, AECs 122a, 122b, 122c, and 122d.

System controller 110 is representative of any standard processing device, such as a personal computer (PC), laptop, or host computer, capable of running system control software for operating OLED display system 100. System controller 110 functions as the system-level controller of OLED display system 100. System controller 110 may be electrically connected to digitizer 112 via a standard connector such as RS232, through which a communications link is established.

Digitizer 112 is a well-known device that converts any video signal to a digital format that can be displayed by OLED display system 100. Digitizer 112 serves as an “input manager” for display wall 114. Various video sources, such as those from system controller 110, that provide signals to be displayed upon display wall 114 may be connected to digitizer 112. Digitizer 112 converts these input signals to a digital signal that is compatible with display wall 114.

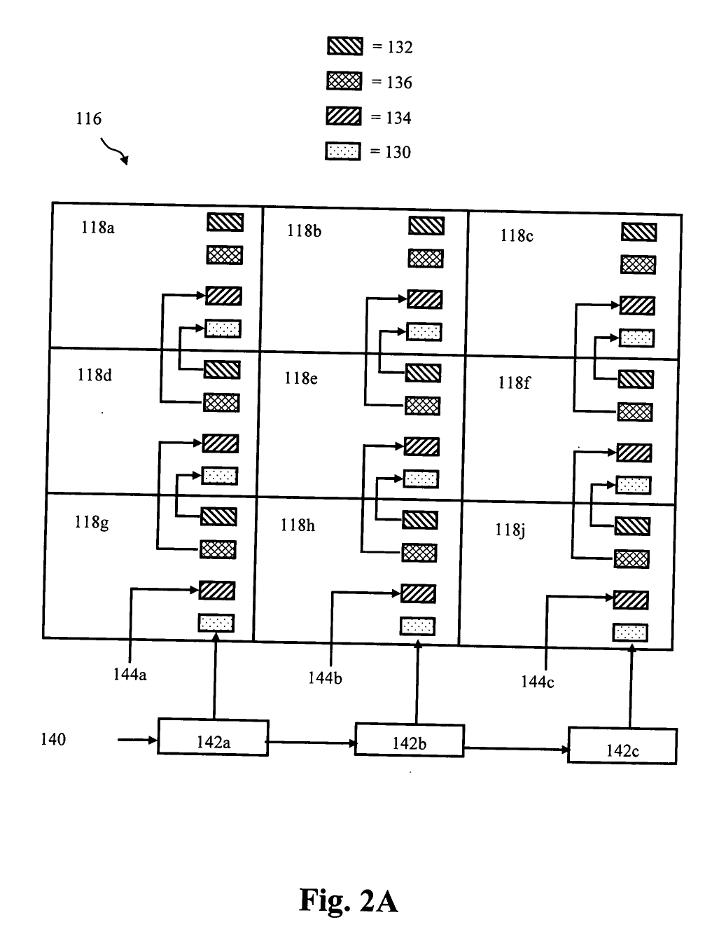

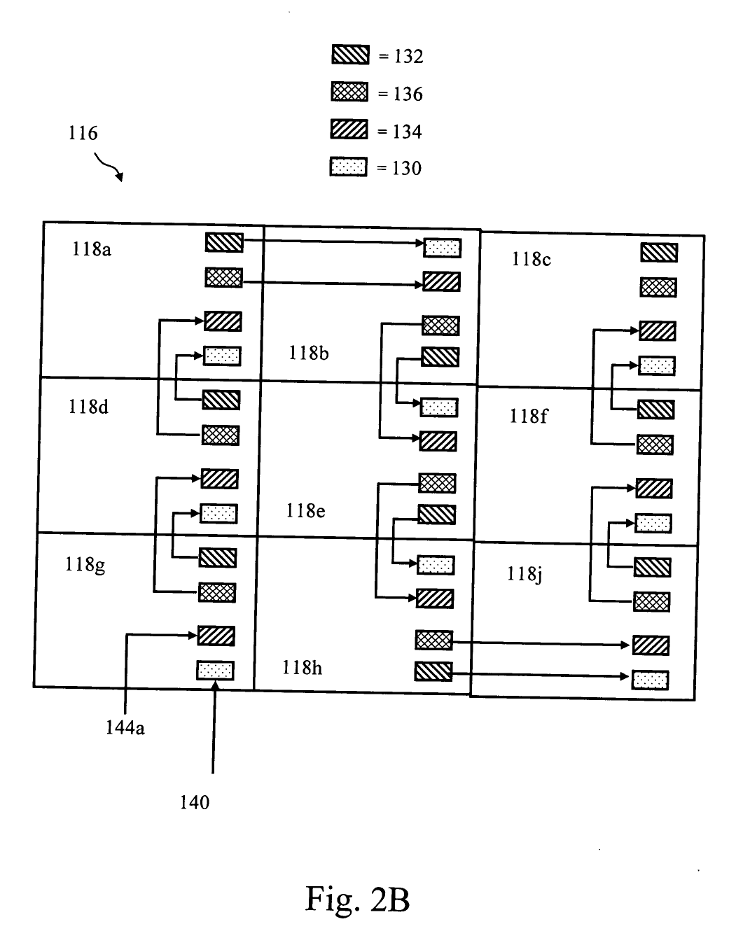

Control data signals, such as serial control data signals, from system controller 110 and video data signals, such as serial RGB video data signals, from any source are supplied to display wall 114 via digitizer 112. The video data signals contain the current video frame information to be displayed on OLED sub-displays 116a, 116b, 116c, 116d. The control data signals provide control information to OLED sub-displays 116a, 116b, 116c, 116d, such as color temperature, gamma, and imaging information for each OLED tile 118 within each OLED sub-display 116. Several methods of signal and power distribution can be used within the display wall 114, e.g. a multi-line method, a star distribution method, or a daisy-chain method. A multi-line method of signal distribution is implemented within display wall 114, and is illustrated in FIG. 2A.

A data input signal DATA IN 140 from a central processing unit (not shown) is supplied to an input of data reclocker 142a. Data input signal 140 is representative of e.g. serial video and control data. Data reclocker 142a subsequently re-transmits this serial video and control data to one OLED tile 118 as well as to a next data reclocker 142, i.e. in the example given, to an input of data reclocker 142b and to a data input connector of OLED tile 118g. Similarly, data reclocker 142b transmits the received serial video and control data signal to an input of data reclocker 142c and to data input connector of OLED tile 118h. Finally, data reclocker 142c transmits the received serial video and control data to a data input connector of OLED tile 118j. This way, the DATA IN signal 140 is distributed to all OLED tiles 118 of one row of the OLED sub-display 116. It is to be noted that the data links in the OLED display are bi-directional, so it is also possible to place data reclockers 142a, 142b, and 142c on top of OLED sub-display 116, instead of placing them at the bottom, thus feeding the DATA IN signal 140 to data input connectors of OLED tiles 118a, 118b, 118c. These bi-directional links also make it possible to pass the data input signal DATA IN 140 from the end of one column to the beginning of the neighbouring column. It is likewise to be noted that the terms “row” and “column” are interchangeable, meaning that the data reclockers may distribute the DATA IN signal 140 to all OLED tiles 118 of one column of the OLED sub-display 116.

A data input connector of an OLED tile 118 provides an electrical connection for receiving video data signals containing the current video frame information to be displayed on OLED tile 118 and for receiving control data signals from data reclocker 142. Subsequently, the video and control data is transferred from one OLED tile 118 to the next OLED tile 118 along a same column if the DATA IN signal 140 was fed to all OLED tiles 118 of a row, or to the next OLED tile 118 along a same row if the DATA IN signal 140 was fed to all OLED tile assemblies of a column. Hereinafter, the situation of FIG. 2A is further described, i.e. the case in which the DATA IN signal 140 was fed to all OLED tiles 118 along a same row. For example with reference to FIG. 2, the video and control data is transferred from OLED tile 118g to OLED tile 118d via an electrical connection between data output connector 132 of OLED tile 118g and data input connector 130 of OLED tile 118d, then from OLED tile 118d to OLED tile 118a via an electrical connection between data output connector 132 of OLED tile 118d and data input connector 130 of OLED tile 118a. Likewise, the video and control data is transferred from OLED tile 118h to OLED tile 118e via an electrical connection between data output connector 132 of OLED tile 118h and data input connector 130 of OLED tile 118e, then from OLED tile 118e to OLED tile 118b via an electrical connection between data output connector 132 of OLED tile 118e and data input connector 130 of OLED tile 118b. Lastly, the video and control data is transferred from OLED tile 118j to OLED tile 118f via an electrical connection between data output connector 132 of OLED tile 118j and data input connector 130 of OLED tile 118f, then from OLED tile 118f to OLED tile 118c via an electrical connection between data output connector 132 of OLED tile 118f and data input connector 130 of OLED tile 118c. In each case, the video and control data is re-transmitted by the control board of each OLED tile 118.

The multi-line method of power distribution is accomplished by AC power connections from one OLED tile 118 to the next OLED tile 118 along the same column or row as follows. A POWER INPUT signal 144a from a mains power supply (not shown) is supplied to OLED tile 118g via an electrical connection to power input connector 134 of OLED tile 118g. AC power is then transferred from OLED tile 118g to OLED tile 118d via an electrical connection between power output connector 136 of OLED tile 118g and power input connector 134 of OLED tile 118d. AC power is then subsequently also transferred from OLED tile 118d to OLED tile 118a via an electrical connection between power output connector 136 of OLED tile 118d and power input connector 134 of OLED tile 118a. Likewise, a POWER INPUT signal 144b from the mains power supply (not shown) is supplied to OLED tile 118h via an electrical connection to power input connector 134 of OLED tile 118h. AC power is then transferred from OLED tile 118h to OLED tile 118e via an electrical connection between power output connector 136 of OLED tile 118h and power input connector 134 of OLED tile 118e. AC power is then transferred from OLED tile 118e to OLED tile 118b via an electrical connection between power output connector 136 of OLED tile 118e and power input connector 134 of OLED tile 118b. Lastly, a POWER INPUT signal 144c from the mains power supply (not shown) is supplied to OLED tile 118j via an electrical connection to power input connector 134 of OLED tile 118j. AC power is then transferred from OLED tile 118j to OLED tile 118f via an electrical connection between power output connector 136 of OLED tile 118j and power input connector 134 of OLED tile 118f. AC power is then transferred from OLED tile 118f to OLED tile 118c via an electrical connection between power output connector 136 of OLED tile 118f and power input connector 134 of OLED tile 118c. The AC input voltage from a power input connector 134 is simply bussed directly to power output connector 136 of the OLED tile 118. Equally to the distribution of the DATA IN signal 140 over the OLED tiles 118, the power distribution may be performed either column-wise or row-wise. Power input connector 134 and power output connector 136 are conventional power connectors e.g. capable of handling up to 265 AC volts and 10 amps.

An alternative distribution method for signal and power distribution is a star distribution (not represented in the drawings). The wording star distribution refers to the fact that the distribution of data signals or power occurs from the centre to the edge of the tiled OLED display 116 or vice versa. In this distribution method, the signals are transferred by a data reclocker 142 to several central OLED tile assemblies 118, each of them further transferring the data signals to tiles at further distance of the centre or the edge respectively of the tiled OLED display 116. In this way, distribution of serial video data and control data is obtained between the OLED tile assemblies from the centre assemblies 118 of the OLED tile display 116 to the edge assemblies 118 or vice versa, so that all OLED tile assemblies 118 obtain their part of the serial video data and control data. If preferred, it is also possible to obtain serial video data and control data transfer from edge assemblies to centre assemblies, i.e. starting at some of the edge assemblies and transferring to neighbouring assemblies ending in or around the centre of the display, so that all OLED tile assemblies 118 obtain their part of the serial video data and control data. In similar way, it is possible to obtain this method of distribution, i.e. star distribution, for the power distribution.

A third distribution method of both serial video and control data and power is illustrated in FIG. 2B. It shows a daisy-chain method of distribution for a tiled OLED display 116. The tiled OLED display 116 is representative of an m by n array of OLED tile assemblies 118. In this example, a 3×3 array is pictured. More specifically, FIG. 2B illustrates that tiled OLED display 116 includes, for example, OLED tile assemblies 118a, 118b, 118c, 118d, 118e, 118f, 118g, 118h, and 118j. It is further illustrated that each OLED tile assembly 118 includes its associated data input connector 130, data output connector 132, power input connector 134, and power output connector 136.

The daisy-chain distribution method of signal distribution is described as follows. A DATA IN signal 140, representative of serial video and control data, from a central processing unit (not shown) is supplied to an input of one OLED tile assembly 118, i.e. in the example given to data input connector 130 of OLED tile assembly 118g. Subsequently, the serial video and control data is transferred from one OLED tile assembly 118 to a next, neighbouring OLED tile assembly 118. For example and with reference to FIG. 2B, the serial video and control data is transferred from OLED tile assembly 118g to OLED tile assembly 118d via an electrical connection between data output connector 132 of OLED tile assembly 118g and data input connector 130 of OLED tile assembly 118d, then from OLED tile assembly 118d to OLED tile assembly 118a via an electrical connection between data output connector 132 of OLED tile assembly 118d and data input connector 130 of OLED tile assembly 118a. The serial video and control data is then further transferred from OLED tile assembly 118a to OLED tile assembly 118b, via an electrical connection between data output connector 132 of OLED tile assembly 118a and data input connector 130 of OLED tile assembly 118b. In similar way, the serial video data and control data are subsequently transferred from OLED tile assembly 118b to OLED tile assembly 118e, from OLED tile assembly 118e to OLED tile assembly 118h, from OLED tile assembly 118h to OLED tile assembly 118j, from OLED tile assembly 118j to OLED tile assembly 118f and from OLED tile assembly 118f to OLED tile assembly 118c. In similar way, the daisy-chain method of power distribution is accomplished by AC power connections from one OLED tile assembly 118 to the next OLED tile assembly 118.

Although the latter method does not allow parallel distribution of the serial video and control data, i.e. distributing of serial video and control data occurs subsequently to a neighbouring tile, it can allow parallel, i.e. simultaneous, processing by the different to OLED tile assemblies.

In FIGS. 2A and 2B, the same distribution method is used to distribute the power and the data. There is however no need to use the same method for data and power distribution.

The communications link between digitizer 112 and OLED sub-displays 116 of display wall 114 may be via, for example, a fibre link, which is a digital fibre optic transmission system. The fibre link may cover very long distances and has a very high bandwidth. The fibre link may transmit not only the video signals but also communication signals to display wall 114.

Using digitizer 112, different video input signals can be combined or overlaid. Since several sources can be connected to digitizer 112 at the same time, it is also possible to display images from several sources at display wall 114 at the same time. These images can be displayed next to each other, or they can be overlaid. The way in which the images are displayed may be edited or changed by moving and scaling “windows” in any known way. A window represents an image from a source, e.g. a video signal, that is connected to digitizer 112. It is possible to change the position of the area upon display wall 114 in which the image is displayed, which is known as “window moving”. It is also possible to change the size of the area in which the image will be displayed, which is known as “window scaling”. Display wall 114 is representative of any user-configurable, modular OLED display formed of a collection of sub-displays 116. Display wall 114 is customizable to any size and dimension by adding or removing OLED sub-displays 116 to achieve the desired display structure. FIG. 1 is illustrative of a sample configuration of display wall 114 that includes OLED sub-displays 116. Furthermore, each OLED sub-display 116 may be configured differently from one another using various configurations of OLED tiles 118 and OLED modules 120 that are uniquely user-defined for any given application.

Additionally, display wall 114 is also maintainable and repairable due to its modularity. For example, an OLED module 120 that does not function properly or contains failed pixels may be replaced with another OLED module 120 by removing the non-functional OLED module 120 and inserting a new OLED module 120 into the backplane of the corresponding OLED tile 118. Analogously, due to the modularity any OLED tile 118, e.g. OLED tile 118a, 118b, 118c, 118d, 118e, 118f, 118g, 118h, or 118j that does not function properly or contains failed OLED modules 120 or failed pixels may be replaced with another OLED tile 118 by removing the non-functional OLED tile 118 and inserting a new OLED tile 118 in the respective OLED sub-display 116. By contrast, large contiguous display systems as known from the prior art must be replaced in their entirety when portions of the display malfunction or when pixels go dark. Therefore, a modular display such as display wall 114 provides a longer display life and has lower replacement costs than conventional large single-unit displays.

Each AEC 122 is a device comprising sensors to measure the ambient environment, such as a temperature sensor, a light sensor, and a humidity sensor for example. One or more AECs 122 are placed in close proximity to display wall 114 to measure environmental parameters during the operation of display wall 114.

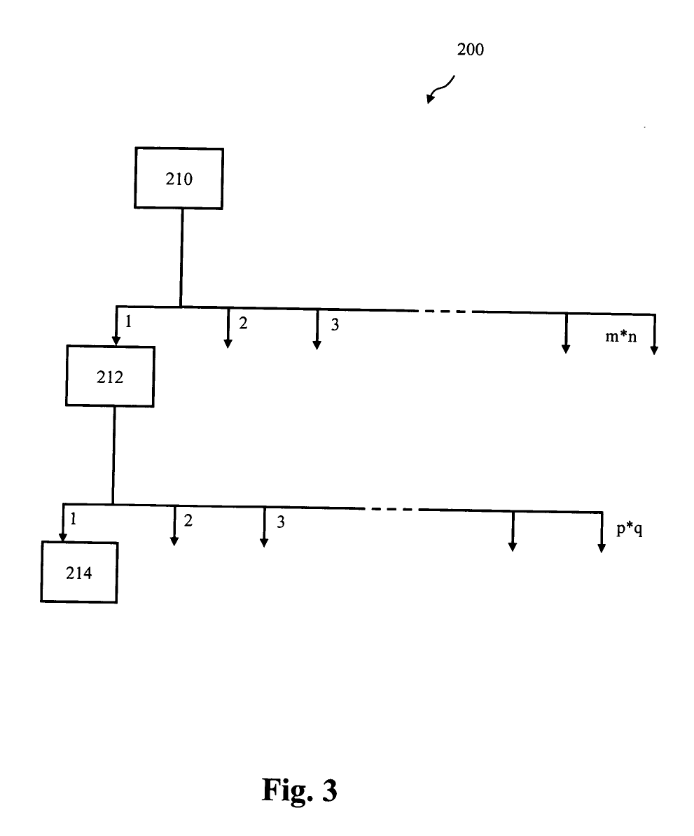

Display wall 114 of OLED display system 100 includes various levels of hardware. The highest hardware level comprises display wall 114 itself, which is formed of a plurality of sub-displays 116; the next lower level comprises OLED sub-displays 116, which are formed of a plurality of OLED tiles 118; the next lower level comprises OLED tiles 118, which are formed of a collection of OLED modules 120; and the lowest level comprises OLED modules 120, which are formed of a collection of individual OLED devices or pixels. The overall control according to the present invention is designed to handle the operation and calibration of the various levels of hardware of display wall 114 using similar algorithms regardless of level. Local processing is available at the fairly low level of each OLED tile 118; thus, the overall control of OLED display system 100 according to the present invention is able to use a distributed processing method. The physical hardware implementation of OLED tiles 118 and the architecture of display wall 114 provide distributed processing that has as a result a less complex display hardware and software system, thereby avoiding the need for high-bandwidth calculations by a central processor, i.e. by system controller 110. The overall control software is described with reference to FIG. 3, 4 and 5.

In an alternative embodiment, a plurality of OLED display systems 100 are networked via e.g. a conventional local area network (LAN), a wide area network (WAN), or Internet to a central processor upon which is loaded the system control software for handling all OLED display systems 100. In this case, the function of system controller 110 of each OLED display system 100 is simply to provide a network connection to each respective digitizer 112 of the OLED display systems 100.

FIG. 3 illustrates a functional block diagram of an OLED display software system 200 in accordance with the present invention. OLED display software system 200 includes a system software component 210, a tile software component 212, and a module software component 214.

OLED display software system 200 provides the overall software control for a modular large-screen OLED display system such as OLED display system 100. System software component 210 is representative of the top level of software control, tile software component 212 is representative of an intermediate level of software control, and module software component 214 is representative of a low level of software control. In operation, information is passed among all levels and specific operations are distributed accordingly under the control of system software component 210. More specifically, and with reference to FIG. 3:

As the top-level controller, system software component 210 performs such tasks as:
1) determining the configuration of OLED display system 100 upon initialization,
2) detecting replacement of OLED tiles 118,
3) running adaptive calibration algorithms for OLED tiles 118,
4) managing the temperature control of OLED tiles 118,
5) running system diagnostics, and
6) running adaptive feature algorithms for OLED tiles 118.

As the mid-level controller, tile software component 212 performs such tasks as:
1) running adaptive calibration algorithms for OLED modules 120,
2) managing the temperature control of OLED modules 120,
3) setting and storing factory settings, such as serial number and production date of OLED tiles 118, and
4) running pre-charge control algorithms for OLED modules 120.

As the low-level controller, module software component 214 performs such tasks as:
1) running adaptive calibration algorithms for individual OLED devices,
2) storing run-time, which is a function of ON time+temperature,
3) maintaining pre-charge control of individual OLED devices,
4) storing light and color values for individual OLED devices, and
5) setting and storing factory settings, such as serial number and production date, of OLED modules 120.

In general, algorithms and functionality are basically the same at all levels of OLED display software system 200. These algorithms and functions are executed by tile software component 212 and/or module software component 214, but decisions or information gathering are typically performed at the top level of system software component 210 by passing values from one level to the next. Thus, a cluster of OLED devices, a cluster of OLED modules 120, and a cluster of OLED tiles 118 are controlled in the same way via OLED display software system 200.

For example, a uniform output across all OLED devices within a given OLED module 120 is ensured via the adaptive calibration, but that does not mean that a uniform output across all OLED modules 120 within a given OLED tile 118 is ensured. Subsequently, once OLED modules 120 are uniform within themselves, all OLED modules 120 outputs must further be made uniform with their neighbors within each OLED tile 118. Likewise, once OLED tiles 118 are uniform within themselves, all OLED tiles 118 outputs must further be made uniform with their neighbors within each OLED sub-display 116 of display wall 114. Using, for example, an adaptive calibration algorithm, the same algorithm may be run at all levels from the lowest to the highest as follows:
1) The adaptive calibration algorithm of module software component 214 reads and calibrates the OLED devices for each OLED module 120. The x,y,Y light outputs and color coordinates are read for every OLED device. Each OLED module 120 is subsequently calibrated to optimal target OLED device x,y,Y coordinates. Values are then passed on to the next higher level, i.e., to tile software component 212.
2) The adaptive calibration algorithm of tile software component 212 reads and calibrates every OLED module 120 for each OLED tile 118. Each OLED tile 118 is subsequently calibrated to the optimal target OLED module 120 x,y,Y coordinates. Values are then passed on to the next higher level, i.e., to system software component 210.
3) The adaptive calibration algorithm of system software component 210 reads and calibrates every OLED tile 118 for each OLED sub-display 116 of display wall 114. Each OLED sub-display 116 is subsequently calibrated to optimal target OLED sub-display 116 x,y,Y coordinates of display wall 114. In this way, a uniform image is ensured throughout the entire display wall 114.

In the above described methods, setting the emissive devices may comprise setting the emissive devices so that they are within 10%, preferably within 5% more preferably within 0.8% of the first level target value. Furthermore setting the first level modules may comprise setting the first level modules so that they are within 10%, preferably within 5% more preferably within 0.8% of the emissive display target value of that emissive display or within 10%, preferably within 5% more preferably within 0.8% of a second level target value, depending on the number of control levels that are used in the method of controlling.

In a similar way, depending on the number of control levels, setting the second level tiles may comprise setting the second level tiles so that they are within 10%, preferably within 5% and most preferably within 0.8% of the emissive display target value of the emissive display or within 10%, preferably within 5% and most preferably within 0.8% of a third level target value.

If further levels are present, setting the further levels may be so that they are within 10%, more preferably within 5% and most preferably within 0.8% of the emissive display target value of the emissive display.

In case of all the above limitations are target values, the actual target value that can be reached can depend on the parameter that is chosen as the target parameter, for example, 0.8% can be achieved for the parameter brightness. This would be a severe condition, for other parameters good target level values could be higher than 0.8%.

An aspect of OLED display software system 200 is that it takes the environment into account. For example, by using a light sensor and a temperature sensor, OLED display software system 200 can ascertain the specific purpose, i.e. the application, e.g. inside or outside projection, of a particular display wall 114. Based upon this knowledge, the display content of the image, i.e. gamma, contrast, brightness, and lifetime, may be adapted.

More specifically, display deficiencies may be dealt with as a feature of OLED display software system 200. For example, if the lifetime of a particular OLED technology is known to be limited to 10,000 hours, and a full white display image, such as a spreadsheet, is desired, the light output is less important than contrast. Thus, light output may be reduced to only 20% brightness while the contrast is increased by adapting the gamma curves, thereby providing a suitable image for this application. In this case, the OLED lifetime is approximately five times the lifetime of an OLED with no brightness adjustments at all. In adjusting brightness, lifetime optimization is achieved.

The nature of the video application, e.g. spreadsheet, movie, etc., can be detected for each OLED tile 118 because each OLED tile 118 receives the full video data stream. Each OLED tile 118 uses just its portion of the video data stream to calculate and keep track of its ON time. For example, for a full white display application, such as a spreadsheet, the average display content is typically greater than 40%, while for video, the average display content is typically less than 40%. Each OLED tile 118 tracks the data it is showing; thus, system software component 210 can request information from each OLED tile 118 concerning the percentage of content displayed, can calculate, based on the information for all OLED tiles 118, whether the content is data or video, and can then issue commands to each OLED tile 118 to adapt its settings accordingly.

As a further example, in the case of a home theatre application used in a very dark environment, the human eye has a different sense of color impression. Thus, the saturation color points may be moved. Similarly, in the case of a movie application used in daylight, the eye is not very sensitive to low light. Thus, the lowlights need not necessarily be color accurate, allowing grayscale accuracy using e.g. only three colors, to be used in the lowlight region instead of exact color.

Each AEC 122 can be assigned a certain percentage of weight, dependent on its relevance, e.g. an AEC 122 positioned next to a light spot and extremely influenced by variances of light is weighted accordingly. A percentage of weight may also be assigned to each separate sensor of a particular AEC 122, e.g. a sensor for temperature, light, humidity. In operation, a weighted average is calculated out of all the measurements and the software responds according to a certain reaction slope. The reaction slope determines the time of response to filter out peaks in light transmission.

From the top level, to the intermediate level, to the low level, i.e. system software component 210, tile software component 212, and module software component 214, respectively, OLED display software system 200 is further described as follows.

System software component 210 is generally responsible for determining the configuration of display wall 114 upon initialization; detecting replacement of OLED tiles 118; performing adaptive calibration, diagnostics, and temperature control of OLED tiles 118; and running an adaptive feature algorithm. A more detailed discussion of these functional capabilities follows:

Configuration of display wall 114, explained for the case where a daisy chain signal and power distribution is used Under the control of system software component 210, a query of display wall 114 is performed by a simple electronic switch system. Upon system initialization, all switches are open. The first OLED tile 118 is detected and is addressed as OLED tile 118 #1. Once OLED tile 118 #1 is addressed, its switch closes automatically to close the link in the daisy chain to the next OLED tile 118. Now the second OLED tile 118 is detected and addressed as OLED tile 118 #2, its switch closes to complete the daisy chain to the next OLED tile 118, and so on until all OLED tiles 118 are detected and addressed. Any information that is needed at run time is extracted during the detection process, for example, the system configuration, diagnostic information, and hardware version. Other parameters queried are, for example, resolution, run time, ID or serial number, diagnostics such as temperature and power supply voltages, software version of each OLED tile 118, factory measurement system used, and production date. OLED display software system 200 according to an embodiment of the present invention allows the flexibility of hardware of different generations to operate together. A software upgrade or downgrade on OLED tiles 118 may be necessary to ensure that each OLED tile 118 has the same software ID. For example, for compatibility, a generation (x+1) OLED tile 118 might have to operate as an older generation (x) OLED tile 118.

Replacement of OLED tiles 118: Each OLED tile 118 has an associated serial number. By reading the serial number of each OLED tile 118, system software component 210 uniquely detects and identifies each OLED tile 118. According to one embodiment, system software component 210 performs continuous polling, i.e., every few seconds, to detect a replacement OLED tile 118. Alternatively, an interrupt may be generated by the action of replacing an OLED tile 118. System software component 210 may also detect which OLED tiles 118 are operational or which may be in the process of being replaced during operation, i.e. those being hot-swapped. System software component 210 detects which OLED tile 118 is swapped. System software component 210 is able to read and store the resolution, the content, the light output, and the compensation level of the OLED tile 118 being replaced. As a result, the replacement OLED tile 118 is updated within seconds by means of the layering of the software.

Adaptive calibration algorithm of OLED tiles 118: A distinction between the “initial calibration” that is performed before display wall 114 leaves the factory, and the “periodic calibration” that is performed every time period T is as follows:
Initial calibration: The brightness Y and color coordinates x, y of each OLED pixel are measured. Taking into account the target brightness and color coordinates the optimal result opt(x,y,Y), i.e. closest to the target, that can be realized with all or substantially all pixels in a module is determined. The same procedure is repeated for each OLED module 120, within each OLED tile 118, within each OLED sub-display 116 of display wall 114.
This initial calibration is necessary since each OLED pixel will differ with respect to color coordinates and luminance, due to fluctuations in the production process, driver properties, power supply and/or temperature issues, etc. Without this initial calibration, there would be a non-uniform image when displaying one of the primary colors over OLED sub-display 116 or when displaying any color derived from the primary colors.
Periodic calibration: After every time period T, a periodic calibration is performed. This periodic calibration is based on the calculated ON time and current and temperature during that ON time, or based on the ON time and voltage changes across the OLEDs during that ON time and the temperature, the aging of each OLED pixel is determined. Digital/analog corrections are performed to compensate for the differential aging of the different OLED pixels within an OLED module 120.
This periodic calibration is necessary to compensate for the aging that will be different for the different pixels, since the ON time and current during ON time will be different for each pixel. Without the periodic calibration, color and brightness non-uniformity's would arise during the lifetime of an initially calibrated OLED module 120.

Temperature control of OLED tiles 118: The temperature of each OLED tile 118 is monitored via an internal temperature sensor in each OLED tile 118. Additionally, the environment temperature of the overall display wall 114 is known via the combined AECs 122. For example, it is desirable to determine whether one specific area of display wall 114 is running hotter than the rest of display wall 114, which is a possibility due to natural convection or, for example, because of the sun shining on that area. In such a case, some action may be needed, such as adjusting the light output of that area of display wall 114.

Diagnostics: Various system health conditions are monitored at regular time intervals via system software component 210. For example, system software component 210 monitors the availability of each OLED voltage within each OLED tile 118, the internal heat of each OLED tile 118 to determine whether cooling fans are failing or operational, the operation of a local processor or local memory within each OLED tile 118, and the operation of any device that is controlled via an RS232 connector or other communication protocol connector. Diagnostic information is available at all times, as OLED tiles 118 are constantly running diagnostics under the control of tile software component 212, updating the diagnostic parameters and storing them locally. The parameters can then be read at any time by system software component 210 to determine whether any action is required. System software component 210 attempts to keep every OLED tile 118 of display wall 114 operating even if an error condition exists; display wall 114 is shut down only when necessary, thereby achieving a certain level of “fault” tolerance. For example, a failed local processor with a given OLED tile 118 does not mean that the display image is lost, it only means that the failed OLED tile 118 will not respond to further commands from system software component 210 or that certain algorithms will not run anymore. It is entirely possible for the failed OLED tile 118 to continue to run in its current state.

Adaptive feature algorithm of OLED tiles 118:

Based on the environmental conditions measured by the AECs 122, system software component 210 determines the intended application and adjusts the display brightness and/or gamma curves to obtain a better contrast and/or adjusts the fan speed, etc. System software component 210 also determines the content of the data stream. Based on the type of content the brightness or contrast can be adapted to gain video/data performance and to increase the lifetime of OLED tile 118.

As previously stated, tile software component 212 is generally responsible for adaptive calibration algorithms and temperature control for OLED modules 120 as described above in regard to system software component 210, setting and storing factory settings such as serial number and production date of OLED tiles 118, or setting and storing of the window a given OLED tile 118 has to display. Furthermore, because the pre-charge operation depends on the normal working voltage across the OLED device and the capacitance of the OLED device, it is necessary to adapt the pre-charge time during the lifetime of the OLED tiles. The pre-charging is done in the current-source driver and can be adjusted by writing a value in the pre-charge time register of the current-source chip. Loading this register is done by tile software component 212.

As previously stated, module software component 214 is generally responsible for running adaptive calibration algorithms for individual OLED devices as described above in regard to system software component 210, storing run-time, i.e. a function of ON time plus temperature, maintaining pre-charge control of individual OLED devices, storing light and color values for individual OLED devices, and setting and storing factory settings such as serial number and production date for OLED modules 120.

In summary, OLED display software system 200 of the present invention performs operations to initialize and configure OLED display system 100, which includes addressing OLED tiles 118, configuring OLED tiles 118 and controlling OLED tiles 118 for uniform image and proper image size. Furthermore, OLED display software system 200 of the present invention handles additional features, including: hot swap capability to replace failed OLED tiles 118 without having to shut down or to reset and recalibrate the entire display wall 114; a mechanism to detect a new OLED tile 118 and to automatically address the new OLED tile 118 so that it is automatically reconfigured to produce the same image rapidly; video features such as gamma curve, the color points, and brightness adjustments; high broadcast capability; and the ability to determine the video content based upon a known data stream, then to reduce or increase the light output based upon that video content in order to gain video/data performance and to maximize lifetime of the OLEDs. Lastly, OLED display software system 200 of the present invention is able to convert display deficiencies into features, i.e. to compensate for deficiencies to improve display image while hiding a particular deficiency. An example of such compensation includes predicting and optimizing lifetime; measuring light output and temperature to set up display wall 114 to perform adequately in that environment; and adjusting gamma curve, color points, and brightness as a function of the environment.

Additionally, display software system 200 controls digitizer 112, thereby achieving a user-defined mixing/overlaying/switching of several video/RGB input sources.

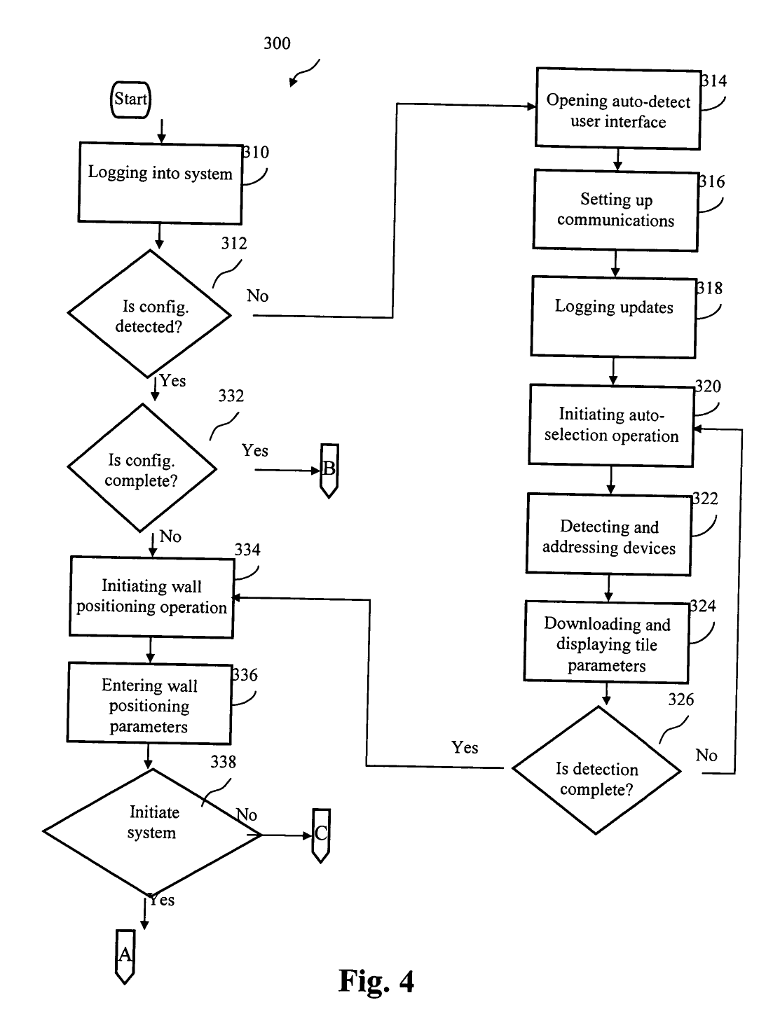

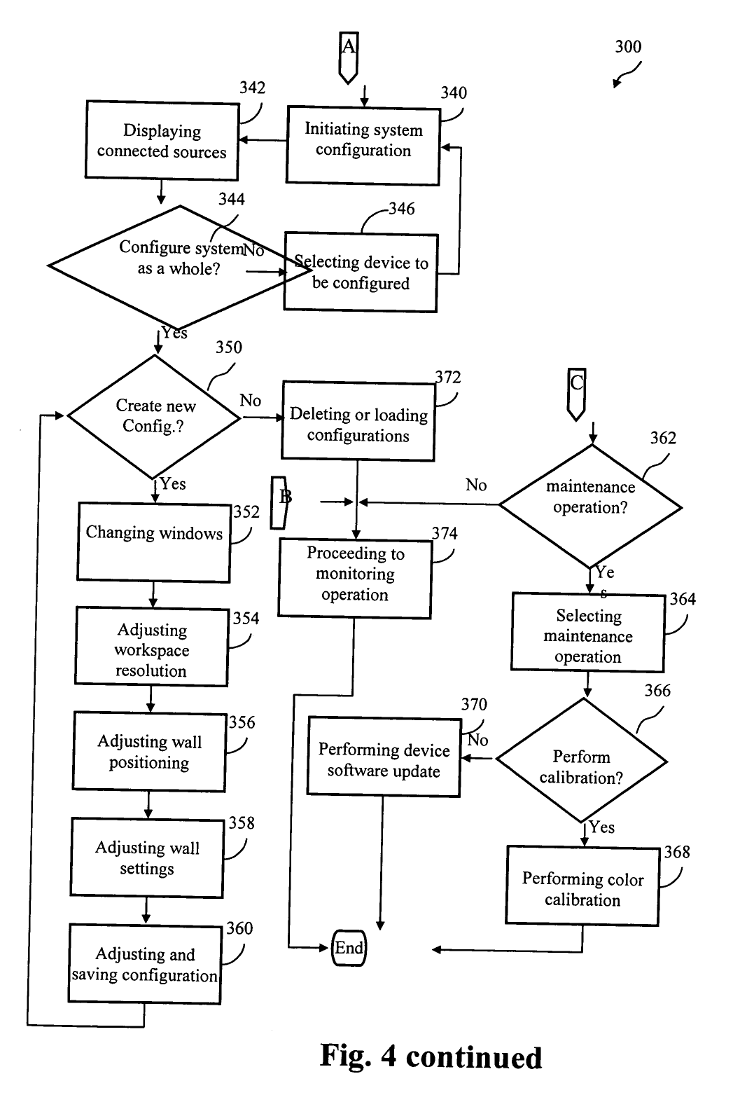

FIG. 4 illustrates a flow diagram of a method 300 of operating a tiled OLED display using OLED display software system 200 in accordance with an embodiment of the invention. Method 300 uses OLED display system 100 of FIG. 1 as an example display system. Furthermore, throughout the steps of method 300, a graphical user interface (GUI) is referenced as the input/output device that facilitates the user interface; however, those skilled in the art will appreciate that other well-known interface methods, such as a command line interface, a touch screen interface, a voice-activated interface, or a menu-driven interface, may be used. Method 300 according to an embodiment of the present invention includes steps as detailed hereunder. It is to be noted that not all of those steps are required for the invention, but that some of them are optional.

Step 310: Logging into System

In this step, using system controller 110, a user logs into OLED display software system 200 of OLED display system 100 by entering a user ID and password via a GUI. Subsequently, OLED display software system 200 validates the entry, thereby granting a valid user access. Method 300 proceeds to step 312.

Step 312. Is Configuration Detected?

In this decision step, OLED display software system 200 interrogates a Configuration Manager of display wall 114 to determine whether a configuration associated with display wall 114 exists. If yes, method 300 proceeds to step 332. If no, method 300 proceeds to step 314.

Step 314. Opening Auto-Detect User Interface

If a configuration associated with display wall 114 does not exist, in this step, OLED display software system 200 initiates an auto-detect process by presenting an “auto-detect” GUI to the user. Method 300 proceeds to step 316.

Step 316. Setting Up Communications

In this step, using the “auto-detect” GUI, the user initiates a communications setup operation. Furthermore, the user initiates a process to adjust the parameter values of the communication link between system controller 110 and digitizer 112. For example, communication port setup operation involves the selection of a serial port number, baudrate, and online/offline status, which indicates whether the software commands have effect on the system being talked to by OLED display software system 200. When ON-LINE all commands are sent and acted on, when OFF-LINE all commands are not sent to the system devices. Method 300 proceeds to step 318.

Step 318: Logging Updates

In this step, OLED display software system 200 logs and stores any changes made during step 316 within system controller 110. Method 300 proceeds to step 320.

Step 320: Initiating Auto-Selection Operation

In this step, using the “auto-detect” GUI, the user initiates a “start auto-selection” operation. Method 300 proceeds to step 322.

Step 322: Detecting and Addressing Devices

In this step, OLED display software system 200 interrogates OLED display system 100 for the presence of all attached devices, i.e. digitizer 112, display wall 114, OLED sub-displays 116, OLED tiles 118, and AECs 122. Subsequently, all devices are addressed in the order in which they are detected in the datalink. More specifically, system controller 110 e.g. detects the presence of the various devices by systematically opening and closing switches to detect the presence and location of each device within OLED display system 100. System controller 110 subsequently assigns each device a unique address for use in steering content and communications data to each. Method 300 proceeds to step 324.

Step 324: Downloading and Displaying Tile Parameters

In this step, all parameters, such as type of connected devices, runtime, software-versions, and serial numbers, etc., of detected devices are downloaded to system controller 110. Status information, such as, for example, type of devices, software-versions, and serial numbers, etc., is displayed to the user via a GUI during the downloading process. Icons of detected devices are made visible to the user via a GUI displaying an overview of OLED display system 100. Method 300 proceeds to step 326.

Step 326: Is Detection Complete?

In this decision step, OLED display software system 200 determines whether the device detection process has been successfully completed by determining whether the number of detected devices corresponds with the expected number of devices, i.e. user gets information of detected devices on the GUI; user knows if none are missing, and whether the software is not able to download all parameters of all connected devices. Otherwise the detection cannot be completed successfully. If yes, method 300 proceeds to step 334. If no, method 300 returns to step 320.

Step 332: Is Configuration Complete?

In this decision step, OLED display software system 200 determines whether the configuration of display wall 114 is complete. When the configuration is known and the wall positioning is already entered, the configuration is considered as complete. Thus, OLED display software system 200 simply checks whether the wall positioning is already known or not. If yes, method 300 proceeds to step 374. If no, method 300 proceeds to step 334.

Step 334: Initiating Wall Positioning Operation

This step is also carried out when previously a configuration associated with display wall 114 did not exist, and has been detected in the mean time. In this step, using a GUI displayed upon system controller 110, the user initiates a “wall positioning” process for positioning display wall 114 in the total video output field. Subsequently, OLED display software system 200 initiates the wall positioning process for display wall 114 by presenting a “wall positioning” GUI to the user. Method 300 proceeds to step 336.

Step 336: Entering Wall Positioning Parameters

In this step, using the “wall positioning” GUI, the user enters pixel coordinates of the upper left corner of display wall 114, resolution of OLED tiles 118, linkage direction, etc. Subsequently, OLED display software system 200 logs and stores the window parameters, i.e. horizontal and vertical start- and stop-pixel coordinate, of each OLED tile 118 within the system controller 110. Method 300 proceeds to step 338.

Step 338: Initiate System Configuration?

In this decision step, the user decides whether he/she wishes to initiate a system configuration process. If yes, method 300 proceeds to step 340. If no, method 300 proceeds to step 362.

Step 340: Initiating System Configuration

In this step, using a GUI displayed upon system controller 110, the user initiates a system configuration process for configuring all OLED sub-displays 116 and OLED tiles 118 of display wall 114. Subsequently, OLED display software system 200 initiates the system configuration process for display wall 114 by presenting a “system configuration” GUI to the user. Method 300 proceeds to step 342.

Step 342: Displaying Connected Sources

In this step, OLED display software system 200 initiates the windowing process in digitizer 112 by presenting a “windowing” GUI to the user, through which all video sources connected via digitizer 112 are visibly displayed to the user with relation to display wall 114. Method 300 proceeds to step 344.

Step 344: Configure System as a Whole?

In this decision step, the user decides whether he or she wishes to configure OLED display system 100 in its entirety. If yes, method 300 proceeds to step 350. If no, method 300 proceeds to step 346.

Step 346: Selecting Device to be Configured

In this step, using a GUI displayed upon system controller 110, the user selects digitizer 112, display wall 114, the connection between the display wall 114 and the digitizer 112, e.g. a Fiberlink, i.e. a fiber-interface to connect display wall 114 to digitizer 112 at a long distance, or an AEC 122 to be configured. If digitizer 112 is selected, the user initiates actions relating to digitizer 112, such as adjusting digitizer settings, adjusting timings of the sync generator, selecting input slots, etc. If display wall 114 is selected, the user initiates actions relating to display wall 114, such as adjusting type, adjusting measurement system, adjusting contrast, adjusting flicker, adjusting mode, adjusting resolution mode, adjusting gamma, adjusting wall positioning, adjusting OLED tiles 118, etc. If the connection, e.g. Fiberlink, is selected, the user initiates actions relating to the connection, such as adjusting status, type, motion of the transmitter and the receiver, adjusting the settings of a reconstruction filter, etc. If an AEC 122 is selected, the user initiates actions relating to the given AEC 122, such as adjusting its settings, e.g. weight, calibration value and status of sensors. After the selected device has been configured, method 300 returns to step 340.

Step 350: Create New Configuration?

In this decision step, the user decides whether he/she wishes to create a new configuration for OLED display system 100. If yes, method 300 proceeds to step 352. If no, method 300 proceeds to step 372.

Step 352: Changing Windows

In this step, using the “windowing” GUI, the user makes any desired changes relating to the connected video sources with regard to the locations where their images are displayed, i.e. windows. For example, the user may choose one or more of the following operations: move windows, scale windows, adjust Z-order or layering scheme of the windows in relation to one another, adjust aspect ratio, select input, select special source-specific actions, e.g. visible, color key, alpha blending, etc., or change a selection of the image ViewPort. ViewPort refers to a positional point on the input image with X and Y coordinates and its associated horizontal distance W and vertical distance H, so it defines a ViewPort or cutout image specific to that input. The ViewPort can be changed by changing the values of X, Y, W, H. Method 300 proceeds to step 354.

Step 354: Adjusting Workspace Resolution

In this step, using a GUI displayed upon system controller 110, the user adjusts the size of the resolution of the work area. The user may adjust the size of the workspace resolution by either zooming in or out of the window and display boxes. The width and height aspect ratio change simultaneously according the adjustments, e.g., an 800×600 resolution can be converted to 520×390 in the workspace area. Method 300 proceeds to step 356.

Step 356: Adjusting Wall Positioning

In this decision step, using the “wall positioning” GUI displayed upon system controller 110, the user adjusts the wall positioning of display wall 114. It is possible to adjust the horizontal and vertical start positions of the display in the work area. It is also possible to adjust the horizontal and vertical resolution of every display tile. Changes can be made from the tile's maximum displayable resolution to values below that maximum. This is quite useful when trying to fill extremely large walls with small source images, as reducing the resolution per tile expands the image. Method 300 proceeds to step 358.

Step 358: Adjusting Wall Settings

In this step, using the “wall settings” GUI displayed upon system controller 110, the user adjusts the settings of display wall 114, such as contrast, flicker, and gamma. Method 300 proceeds to step 360.

Step 360: Adjusting and Saving Configuration

In this step, using a GUI displayed upon system controller 110, the user initiates a configuration management operation for display wall 114. The user may save the setup of display wall 114 in configuration files, which contain all the settings of OLED display system 100. The user may save or recall as many configurations as requested. By downloading a configuration to display wall 114, all the settings, such as positioning, flicker, and contrast, are updated immediately. Method 300 returns to step 350.

Step 362. Maintenance Operation?

In this decision step, the user decides whether he or she wishes to initiate a maintenance operation upon OLED display system 100. If yes, method 300 proceeds to step 364. If no, method 300 proceeds to step 374.

Step 364: Selecting Maintenance Operation

In this step, using a GUI displayed upon system controller 110, the user initiates the maintenance operation, such as for example a software/firmware update for all connected devices or a color calibration adjustment, for OLED display system 100. Subsequently, OLED display software system 200 initiates the maintenance operation for OLED display system 100 by presenting a “maintenance” GUI to the user. Method 300 proceeds to step 366.

Step 366: Perform Calibration?

In this decision step, the user decides whether he or she wishes to initiate a calibration operation upon OLED display system 100. If yes, method 300 proceeds to step 368. If no, method 300 proceeds to step 370.

Step 368: Performing Color Calibration

In this step, using the “maintenance” GUI displayed upon system controller 110, the user defines the color temperature and selects the range of OLED tiles 118 to be calibrated. It is possible to calibrate the entire display wall 114 or to calibrate only a range of OLED tiles 118. For example, calibrating only OLED tiles 118 with addresses ranging from 4 to 7. Subsequently, the user initiates a color calibration operation upon display wall 114 and OLED display software system 200 performs the color calibration operation upon the selected OLED tiles 118 of display wall 114. The color calibration reads all color measurements, i.e. measurements done at the factory and stored in each OLED tile 118, and aging factors of all OLED tiles 118, and uses these to calculate correction values, which then are sent to OLED tiles 118, resulting in a uniform image. Method 300 ends.

Step 370: Performing Device Software Update

In this step, using a GUI displayed upon system controller 110, the user initiates a device software update operation for OLED display system 100 and further selects the specific device to be updated. Subsequently, OLED display software system 200 initiates the device software update operation for OLED display system 100 by presenting an “update software” GUI to the user. The user then selects the update files and OLED display software system 200 performs the device software update operation. In this step it is possible to update the software/firmware of all the connected devices. Using a GUI displayed upon system controller 110, the user selects the device icon for which the software has to be updated and places the update files in the appropriate directory. Method 300 ends.

Step 372: Deleting or Loading Configurations

In this step, using the “configuration manager” GUI displayed upon system controller 110, the user either deletes or loads configurations relating to OLED display system 100. In step 360, the defined configuration was saved. In the same way it is possible that configurations have been saved during previous display configurations. These older configurations may now be loaded or they can be deleted. Method 300 proceeds to step 374.

Step 374: Proceeding to Monitoring Operation

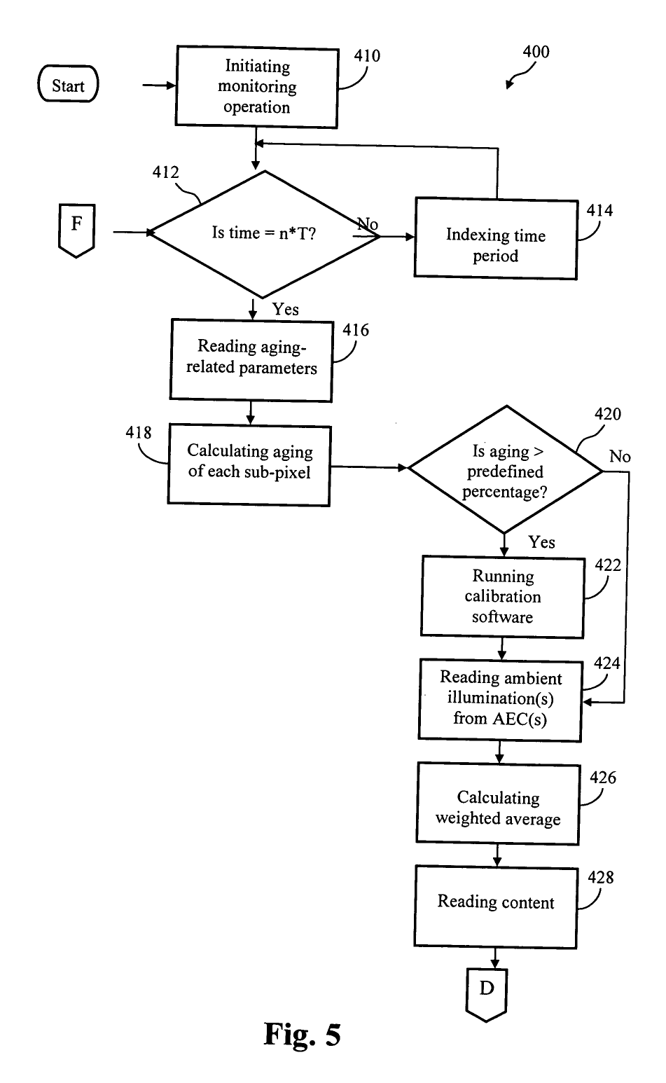

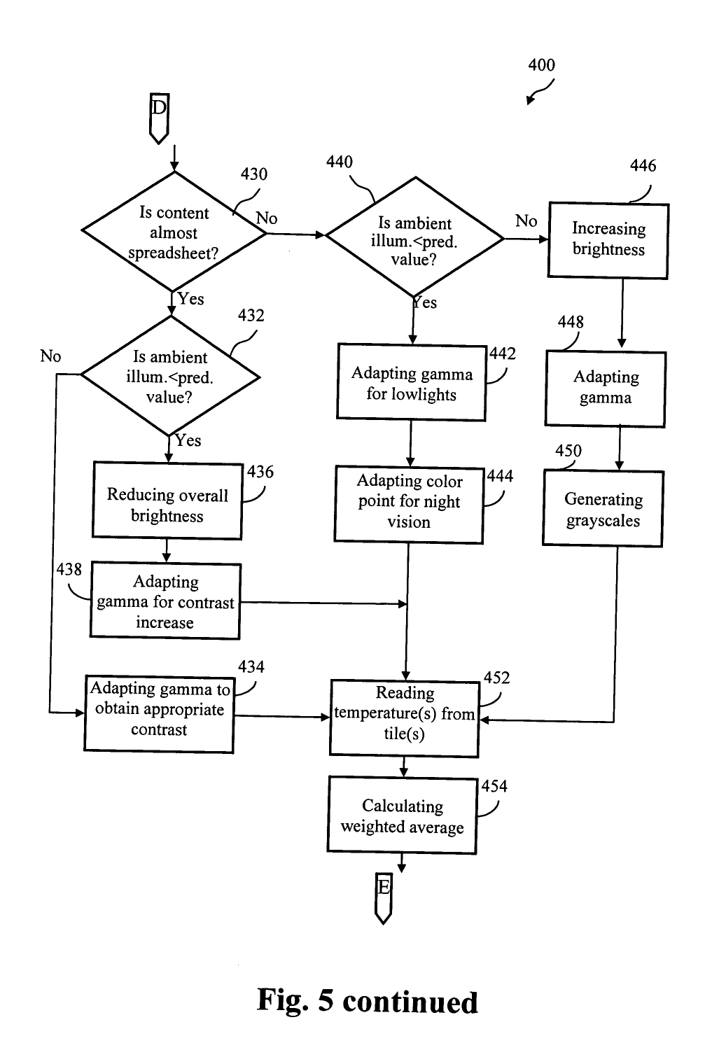

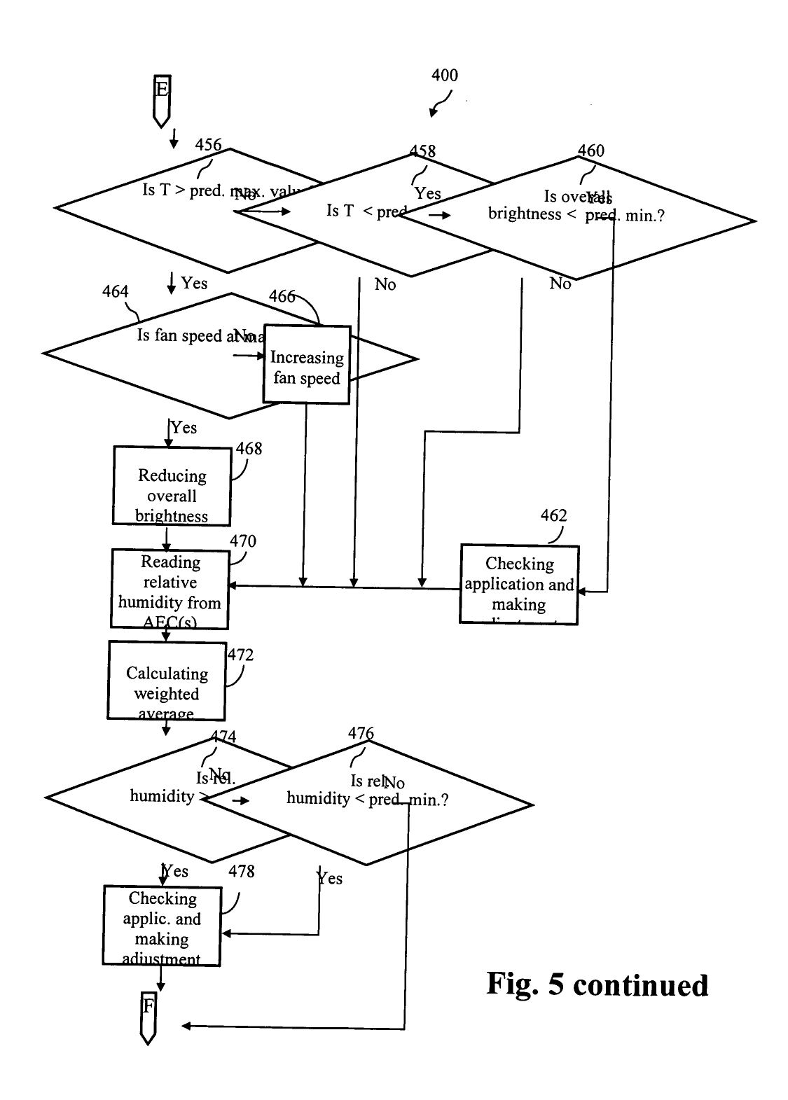

In this step, using a GUI displayed upon system controller 110, the user initiates a system monitoring operation for OLED display system 100. Subsequently, OLED display software system 200 initiates the system monitoring operation for OLED display system 100 by presenting a “monitoring” GUI to the user. Full details of the system monitoring operation are found in reference to a method 400 of FIG. 5; however, a summary of the system monitoring operation is provided as follows.

Using the “monitoring” GUI displayed upon system controller 110, the user views the settings for AECs 122. The user may perform the following tasks:
adjust various settings, e.g., the minimum/maximum contrast, the ambient temperature range, the ambient illumination range, the reaction slope, and the interval;
adjust settings for AECs 122, e.g., the weight and status of each AEC 122;
adjust the application for OLED display system 100, e.g., home theatre, control rooms, and events; or
start or stop the system monitoring operation.

OLED display software system 200 of OLED display system 100 periodically, i.e. the period is determined by a specified interval, reads the temperature, content, ambient illumination, aging, and relative humidity relating to display wall 114. OLED display software system 200 performs adjustment depending on the parameter values. Method 300 ends.

FIG. 5 illustrate a flow diagram of a method 400 of monitoring a tiled OLED display using OLED display software system 200 in accordance with an embodiment of the invention. Method 400 uses OLED display system 100 of FIG. 1 as an example display system. Generally, the software control system of OLED display system 100 periodically reads the temperature, content, ambient illumination, aging, and relative humidity relating to display wall 114, and then performs adjustments depending on the parameter values according to method 400.

Furthermore, throughout the steps of method 400, a GUI is referenced as the input/output device that facilitates the user interface; however, those skilled in the art will appreciate that other well-known interface methods, such as a command line interface, a touch screen interface, a voice-activated interface, or a menu-driven interface, may be used. Method 400 includes the following steps:

Step 410: Initiating Monitoring Operation

In this step, using a GUI displayed upon system controller 110, the user initiates a system monitoring operation for OLED display system 100. Subsequently, OLED display software system 200 initiates the system monitoring operation by presenting a “monitoring” GUI to the user, who defines a time period T for monitoring OLED display system 100. Method 400 proceeds to step 412.

Step 412: Is Time=n*T?

In this decision step, OLED display software system 200 determines whether a predetermined time interval n*T has elapsed since the last system monitoring operation was performed; where n is an integer number: n=1, 2, 3, and where T is a predefined period of time. The monitoring actions will be performed every time that a time period T has elapsed. If yes, method 400 proceeds to step 416. If no, method 400 proceeds to step 414.

Step 414: Indexing Time Period

In this step, OLED display software system 200 indexes the time period by, for example, five minutes. Method 400 returns to step 412.

Step 416: Reading Aging-Related Parameters

In this step, OLED display software system 200 reads aging-related parameters, such as ON time, current during ON time, voltage across the OLED, temperature, color measurements, from a local storage of each OLED tile 118. Method 400 proceeds to step 418.

Step 418: Calculating Aging of Each Sub-Pixel

In this step, OLED display software system 200 calculates the aging of each red, green, and blue sub-pixel within each pixel of each OLED module 120 of each OLED tile 118 of each OLED sub-display 116 of display wall 114. The comparison of the initial voltage across the OLED device and measured voltage across the OLED device is an indication for the aging of the OLED device. The ON time and current during the ON time allows calculating the total charge that passed through the OLED device. This total charge is also a measure for the aging of the OLED devices. Also the temperature, measured on regular basis, has an influence on the aging. Method 400 proceeds to step 420.

Step 420: Is Aging>Predefined Percentage?

In this decision step, OLED display software system 200 determines whether the aging calculated in step 418 is greater than a predefined percentage for any given sub-pixel. If yes, method 400 proceeds to step 422. If no, method 400 proceeds to step 424.

Step 422: Running Calibration Software

In this step, OLED display software system 200 performs a calibration operation upon the target sub-pixel(s). More specifically, after every time period T, a periodic calibration is performed. The calibration is based on the aging of each OLED. This aging of each OLED is determined based on the calculated ON time and current and temperature during that ON time or based on the ON time and voltage changes across the OLEDs and the temperature during that ON time. Digital/analog corrections are performed to compensate for the differential aging of the different OLED pixels within an OLED module 120. This periodic calibration is necessary to compensate for the aging that will be different for the different pixels, since the ON time and current during ON time will be different for each pixel. Without the periodic calibration color and brightness non-uniformities would arise during the lifetime of an initially calibrated OLED module 120. Method 400 proceeds to step 424.

Step 424: Reading Ambient Illumination(s) from AEC(s)

In this step, OLED display software system 200 reads the ambient illumination(s) from AECs 122 mounted within display wall 114. The measured ambient illumination level is used in steps 432 and 440 to allow making appropriate gamma/brightness changes in order to optimize the display performance. Method 400 proceeds to step 426.

Step 426: Calculating Weighted Average

In this step, OLED display software system 200 calculates the weighted average of the ambient illumination levels measured by the various light sensors of the various AECs 122 by taking into account the weight of each AEC 122 and the weight of each light sensor within each AEC 122. For example, assume that two AECs 122 are placed next to display wall 114, assume that the first AEC 122 has a weight of X% and the second AEC 122 has a weight of Y%, e.g. it is possible that X is much smaller than Y if the first AEC 122 is positioned next to a light spot, and assume that each AEC 122 has four light sensors, with the following measured values and weights:

| | | Value (lux) | Weight (%) |
|---|---|---|---|
| First AEC 122 | Sensor 1a | a1 | Wa1 |
| | Sensor 1b | b1 | Wb1 |
| | Sensor 1c | c1 | Wc1 |
| | Sensor 1d | d1 | Wd1 |
| Second AEC 122 | Sensor 2a | a2 | Wa2 |
| | Sensor 2b | b2 | Wb2 |
| | Sensor 2c | c2 | Wc2 |
| | Sensor 2d | d2 | Wd2 |

The weighted average can than be calculated as:

$$WeightedAverage = \frac{\begin{matrix}X \% \cdot \frac{a1 \cdot Wa1 + b1 \cdot Wb1 + c1 \cdot Wc1 + d1 \cdot Wd1}{4} + \\ Y \% \cdot \frac{a2 \cdot Wa2 + b2 \cdot Wb2 + c2 \cdot Wc2 + d2 \cdot Wd2}{4}\end{matrix}}{2}$$

Method 400 proceeds to step 428.

Step 428: Reading Content

In this step, OLED display software system 200 reads the content type of the displayed video from the input data stream for determining the nature of the application. Method 400 proceeds to step 430.

Step 430: Is Content Almost “Spreadsheet”?

In this decision step, by analyzing the content read in step 428, OLED display software system 200 determines whether the content is almost “spreadsheet”, i.e. is nearly a full white image. If full white operations are represented by a “power factor =1” and video operation can be represented by a “power factor=⅛=0.125”, nearly a full white image refers to an image having a power factor equal to or larger than 0.56. If yes, method 400 proceeds to step 432. If no, method 400 proceeds to step 440.

Step 432: Is Ambient Illumination<Predefined Value?

In this decision step, by analyzing the ambient illumination(s) read in step 424, OLED display software system 200 determines whether the ambient illumination is less than a 20 predefined value of, for example, 200 lux. If yes, method 400 proceeds to step 436. If no, method 400 proceeds to step 434.

Step 434: Adapting Gamma to Obtain Appropriate Contrast

In this step, OLED display software system 200 runs algorithms to adapt the gamma curve of each OLED module 120 to obtain appropriate contrast by selecting another gamma preset curve or by changing one or more of ten points that define the current gamma curve. The gamma value is a curve defined by ten points, i.e. one starting slope point, one ending slope point and four x, y coordinate points in between and is used to convert the 8-bit digitized RGB data into a 16-bit value. In this way 256 different input values can be transformed to 65536 output values; a linear input can be converted to any non-linear output which corresponds better with the human eye sensitivity. This output is used by CCD controller to control the ON time of the current sources. An appropriate choice of the gamma curves allows to improve the display performance, e.g. to improve the contrast in the high-lights. There are several gamma preset curves to choose from. It is also possible to construct another gamma by moving one or more of the four pairs that define the gamma curve. Method 400 proceeds to step 452.

Step 436: Reducing Overall Brightness

In this step, if the ambient illumination is less than a predetermined value, OLED display software system 200 reduces the overall brightness of display wall 114 by reducing the brightness of each primary emitter by the same percentage. The purpose of this operation is to increase the lifetime of display wall 114, and to prevent display wall 114 from emitting too much light in a dark environment. For example, at night, watching a very bright display wall 114 is not comfortable to the eye for viewing. Each color in display wall 114 can be described by its tristimulus values X, Y, Z in the CIE color space. The Y value represents contributions to the brightness perception of the human eye and it is called the brightness or luminance. A color can also be described by Y and the color functions x, y, z; where

$$x = \frac{X}{X + Y + Z} , y = \frac{Y}{X + Y + Z} , z = \frac{Z}{X + Y + Z} ,$$

and x+y+z=1.
In this step the brightness of each primary color Y_{R}, Y_{B}, and Y_{G} is decreased by a percentage factor, for example 10%. The overall brightness of display wall 114 will therefore decrease by the same percentage factor. Method 400 proceeds to step 438.

Step 438: Adapting Gamma for Contrast Increase

In this step, OLED display software system 200 runs algorithms to adapt the gamma curve of each OLED module 120 to obtain appropriate contrast by selecting another gamma preset curve or by changing one or more of a plurality of points, e.g. ten points, that define the current gamma curve. In this case a gamma curve is selected that gives rise to an increased contrast in a dark environment. Method 400 proceeds to step 452.

Step 440. Is Ambient Illumination<Predefined Value?

In this decision step, carried out when the content read in step 428 is not nearly a full white image i.e. if the image has a power factor lower than 0.56, by analyzing the ambient illumination(s) read in step 424, OLED display software system 200 determines whether the ambient illumination is less than a predefined value of, for example, 200 lux. If yes, method 400 proceeds to step 442. If no, method 400 proceeds to step 446.

Step 442: Adapting Gamma for Lowlights

In this step, OLED display software system 200 runs algorithms to adapt the gamma curve of each OLED module 120 for improved display performance at lowlights by selecting another gamma curve. See step 434 for more details. Method 400 proceeds to step 444.

Step 444: Adapting Color Point for Night Vision

In this step, OLED display software system 200 runs algorithms to adapt the color point of each OLED module 120 for night vision. In a dark environment, the color impression is different. Therefore, the saturation color point needs to be moved to improve the color reproduction on display wall 114. Method 400 proceeds to step 452.

Step 446: Increasing Brightness

In this step, carried out when the ambient illumination is not smaller than a predetermined value, OLED display software system 200 runs algorithms to increase the brightness of display wall 114 by increasing the brightness of each primary emitter by the same percentage. In this step the brightness of each primary color Y_{R}, Y_{B}, and Y_{G} is increased by a percentage factor, for example 10%. The overall display brightness will therefore increase by the same percentage factor. As a result of this action, the performance of display wall 114 will increase, but the lifetime of display wall 114 will decrease. Method 400 proceeds to step 448.

Step 448: Adapting Gamma

In this step, OLED display software system 200 runs algorithms to adapt the gamma curve of each OLED module 120 to increase the contrast by selecting another gamma curve. See step 434 for more details. Method 400 proceeds to step 450. Step 450: Generating Grayscales

In this step, OLED display software system 200 runs algorithms to generate grayscales of each pixel within each OLED module 120 within each OLED tile 118 within each OLED sub-display 116 of display wall 114 using e.g. the three primary colors of the pixels. The purpose of this operation is to increase the lifetime of display wall 114. In a bright environment, display wall 114 does not have to be color accurate, but display wall 114 has to be grayscale accurate. As a consequence, the three colors can be used to generate the gray scales. Method 400 proceeds to step 452.

Step 452: Reading Temperature(s) from Tile(s)

In this step, OLED display software system 200 reads the temperature(s) from OLED tiles 118. The temperature has a serious influence on the lifetime of OLED tiles 118. It is a rule of thumb that the display lifetime decreases by a factor of two for every temperature raise of 10 ° C. The knowledge of the temperature allows appropriate actions to be taken to limit the aging of the OLED devices within OLED tiles 118, as shown in steps 464, 466 and 468. Method 400 proceeds to step 454.

Step 454: Calculating Weighted Average

In this step, OLED display software system 200 calculates the weighted average of the temperature measured in OLED tiles 118. Method 400 proceeds to step 456.

Step 456: Is Temperature>Predefined Max. Value?

In this decision step, by analyzing the weighted average temperature calculated in step 454, OLED display software system 200 determines whether the temperature is larger than a predefined maximum value of, for example, 35° C. If yes, method 400 proceeds to step 464. If no, method 400 proceeds to step 458.

Step 458: Is Temperature<Predefined Min. Value?

In this decision step, by analyzing the weighted average temperature calculated in step 454, OLED display software system 200 determines whether the temperature is less than a predefined minimum value of, for example, 25° C. If yes, method 400 proceeds to step 460. If no, method 400 proceeds to step 470.

Step 460: Is Overall Brightness Level<Predefined Min. Value?

In this decision step, by analyzing the brightness of display wall 114, OLED display software system 200 determines whether the overall brightness level of display wall 114 is less than a predefined minimum value of, for example, 100 nit. If yes, method 400 proceeds to step 462. If no, method 400 proceeds to step 470.

Step 462: Checking Application and Making Adjustment

In this step, OLED display software system 200 verifies the application in which display wall 114 is being used and makes adjustments. For example, in a home theatre application in a bright environment the brightness of display wall 114 may be increased in order to increase the performance. Example applications include home theatre, control rooms, events, etc. Method 400 proceeds to step 470.

Step 464: Is Fan Speed Maximum?

In this decision step, OLED display software system 200 determines whether cooling fans within each OLED tile 118 are operating at its maximum speed by checking the voltage used to drive the cooling fans. If yes, method 400 proceeds to step 468. If no, method 400 proceeds to step 466.

Step 466: Increasing Fan Speed

In this step, OLED display software system 200 issues commands to increase the operating speed of cooling fans within one or more targeted OLED tiles 118. It is to be noted that adjusting of the fan-speed is normally done independently within each OLED tile 118 without control of system controller 110. Method 400 proceeds to step 470.

Step 468: Reducing Overall Brightness

In this step, OLED display software system 200 reduces the overall brightness of display wall 114 by reducing the brightness of each primary emitter by the same percentage. The purpose of this operation is to increase the lifetime of display wall 114. In this step the brightness of each primary color Y_{R}, Y_{B}, and Y_{G} is decreased by, for example, 10%. The overall brightness of display wall 114 will therefore decrease by the same percentage. Method 400 proceeds to step 470.

Step 470: Reading Relative Humidity from AEC(s)

In this step, OLED display software system 200 reads the relative humidity from AECs 122 mounted within display wall 114. In an environment with a high relative humidity the lifetime of the OLED devices will be shorter than the lifetime of OLED devices in an environment with a very low relative humidity. The knowledge of the relative humidity allows the appropriate actions to be taken in order to increase the lifetime of display wall 114, such as in case of very high relative humidity; and to improve the performance of display wall 114 in the case of a very low relative humidity. Method 400 proceeds to step 472.

Step 472: Calculating Weighted Average

In this step, OLED display software system 200 calculates the weighted average of the relative humidity measured by the different humidity sensors of the different AECs 122 by taking into account the weight of each AEC 122 and the weight of each humidity sensor within each AEC 122. The calculation is analogous to the calculation described in step 426, apart from the fact that the a1, b1, c1, d1, a2, b2, c2 and d2 are now the relative humidity values in %. Method 400 proceeds to step 474.

Step 474: Is Relative Humidity>Predefined Max. Value?

In this decision step, by analyzing the weighted average relative humidity calculated in step 472, OLED display software system 200 determines whether the relative humidity is greater than a predefined maximum value of, for example, 80%. If yes, method 400 proceeds to step 478. If no, method 400 proceeds to step 476.

Step 476: Is Relative Humidity<Predefined Minimum Value?

In this decision step, by analyzing the weighted average relative humidity calculated in step 472, OLED display software system 200 determines whether the relative humidity is less than a predefined minimum value of, for example, 20%. If yes, method 400 proceeds to step 478. If no, method 400 returns to step 412.

Step 478: Checking Application and Making Adjustment

In this step, OLED display software system 200 verifies the application in which display wall 114 is being used and makes adjustments, such as increasing the brightness if relative humidity is very low and if this is useful for the application. If the relative humidity is very high, actions will be taken to reduce the aging of the OLED devices, e.g. by decreasing the overall brightness. If the relative humidity is very low, actions will be taken to increase the performance of display wall 114, e.g. increase brightness or do nothing but just benefit from the reduced aging due to the low humidity. Example applications include home theatre, control rooms, events, etc. Method 400 returns to step 412.

1. A method for controlling a tiled large-screen emissive display (100), said emissive display (100) comprising at least a plurality of first subdivisions, each of said first subdivisions comprising a plurality of emissive devices, said method comprising
for each of the first subdivisions, setting the emissive devices so that each of said first subdivisions is optimized with respect to a first subdivision target value for that first subdivision, and
after setting the emissive devices,
for the emissive display (100), setting the first subdivisions so that said emissive display is optimized with respect to an emissive display target value for said emissive display (100).

2. A method according to claim 1, said plurality of first subdivisions being grouped into a plurality of second subdivisions, wherein said setting the first subdivisions is performed by
for each of the second subdivisions, setting the first subdivisions so that each of said second subdivision is optimized with respect to a second subdivision target value for that second subdivision, and thereafter
for the emissive display (100), setting the second subdivisions so that the emissive display is optimized with respect to an emissive display target value for said emissive display (100)

3. A method according to claim 2, said plurality of second subdivisions being grouped into a plurality of further subdivisions, wherein said setting the second subdivisions is performed by
for each further subdivision, setting the second subdivisions so that the further subdivision is optimized with respect to a further subdivision target value for said further subdivision, and
after setting said second subdivisions
for the emissive display (100), setting the further subdivisions so that the emissive display is optimized with respect to an emissive display target value for said emissive display (100)

4. A method according to claim 1, wherein said first subdivision is an emissive display tile (118).

5. A method according to claim 2, wherein said first subdivision is an emissive display module (120) and said second subdivision is a display tile (118).

6. A method according to claim 3, wherein said further subdivision is an emissive display supertile.

7. The method according to claim 1, wherein for each first subdivision, setting the emissive devices comprises setting the emissive devices so that they are within 10%, preferably within 5% and most preferably within 0.8% of the first subdivision target value of that first subdivision.

8. The method according to claim 1, wherein for said emissive display (100), setting the first subdivisions comprises setting the first subdivisions so that they are within 10%, preferably within 5% and most preferably within 0.8% of the emissive display target value of that emissive display (100).

9. The method according to claim 2, wherein setting the first subdivisions comprises setting the first subdivisions so that they are within 10%, preferably within 5% and most preferably within 0.8% of the second subdivision target value of that second subdivision and
wherein setting the second subdivisions comprises setting the second subdivisions so that they are within 10%, preferably within 5% and most preferably within 0.8% of the emissive display target value of the emissive display (100).

10. The method according to claim 3, wherein setting the first subdivisions comprises setting the first subdivisions so that they are within 10%, preferably within 5% and most preferably within 0.8% of the second subdivision target value of that second subdivision, and
wherein setting the second subdivisions comprises setting the second subdivisions so that they are within 10%, preferably within 5% and most preferably within 0.8% of the further subdivision target value of that further subdivision, and
wherein setting the further subdivisions comprises setting the further subdivisions so that they are within 10%, preferably within 5% and most preferably within 0.8% of the emissive display target value of the emissive display target value.

11. The method according to claim 1, wherein in determining any or more of the first subdivision target value, second subdivision target value, the further subdivision target value and/or emissive display target value, an environmental parameter is taken into account.

12. The method according to claim 11, wherein the environmental parameter is obtained by measuring a temperature of at least one emissive device, first subdivision, second subdivision or further subdivision.

13. The method according to claim 11, wherein taking into account the environmental parameter includes measuring an ambient temperature and estimating the temperature of at least one emissive device, first subdivision, second subdivision or further subdivision from the measured ambient temperature.

14. The method according to claim 11, wherein the environmental parameter is any or more of ambient illumination, ambient humidity.

15. The method according to claim 1, wherein in determining any or more of the first subdivision target value, second subdivision target value, further subdivision target value and/or emissive display target value, an operating parameter stored on the first subdivision or second subdivision or further subdivision is taken into account.

16. The method according to claim 15, wherein the operating parameter comprises any or more of age of the first subdivision or of the second subdivision or of the further subdivision, or total ON time of the first subdivision or of the second subdivision or of the further subdivision.

17. The method according to claim 1, wherein setting the emissive devices comprises retrieving and adjusting a control parameter.

18. The method according to claim 1, wherein setting the emissive devices, the first subdivisions, the second subdivisions and the further subdivisions comprises an adaptive calibration algorithm for calibrating the emissive devices, the first subdivisions, the second subdivisions and the further subdivisions.

19. The method according to claim 18, wherein the calibration is performed periodically.

20. The method according to claim 18, wherein said calibration comprises calibration of brightness and/or color.

21. A computer program product for executing the method of claim 1, when executed on a computing device associated with a tiled large-screen emissive display (100).

22. A machine readable data storage device storing the computer program product of claim 21.

23. Transmission of the computer program product of claim 21 over a local or wide area telecommunications network.

24. A control unit for use with a tiled large-screen emissive display (100), said emissive display (100) comprising a set of first subdivisions, each of said first subdivisions comprising a plurality of emissive devices, the control unit being adapted for controlling setting of the tiled large-screen emissive display (100), the control unit comprising:
means for setting the emissive devices of each first subdivision so that each first subdivision is optimized to a first subdivision target value for that first subdivision,
means for setting the first subdivisions of the emissive display (100) taking into account the first subdivision target value for each first subdivision, so that the emissive display (100) is optimized to an emissive display target value for that emissive display (100).

25. A control unit according to claim 24 for use with a tiled large-screen emissive display (100), said first subdivisions being grouped in a set of second subdivisions, the means for setting the first subdivisions comprising
means for setting the first subdivisions of each of the second subdivisions, taking into account the first subdivision target value for each first subdivision, so that each second subdivision is optimized to a second subdivision target value for that second subdivision,
means for setting the second subdivisions of the emissive display (100) taking into account the second subdivision target values for each of the second subdivisions, so that the emissive display (100) is optimized to an emissive display target value for that emissive display (100).
